(19) United States
(12) Patent Application Publication
(10) Pub. No.: US 2015/0339612 A1
(43) Pub. Date: Nov. 26, 2015

(54) Electronic Organizational Performance Improvement and Social Responsibility Implementation Architecture and Process

(71) Applicants: Donald Feaver, Brighton (AU); Benedict Sheehy, Reservoir (AU)

(72) Inventors: Donald Feaver, Brighton (AU); Benedict Sheehy, Reservoir (AU)

(21) Appl. No.: 14/707,476

(22) Filed: May 8, 2015

(30) Foreign Application Priority Data
May 12, 2014 (CA) 2847762

(51) Int. Cl. G06Q 10/06; G06Q 30/00

(52) U.S. Cl. CPC G06Q 10/06393; G06Q 30/018

(57) ABSTRACT

This invention relates to the creation of a framework and process for improving organizational performance through the adoption and implementation of social responsibility standards by public or private organizations. This invention relates to the configuration of computer software applications that coordinate and perform specific business or organizational process functions that assist in the implementation of the social responsibility standards and process improvements. The invention includes a description of the positioning of the software applications as well as the composition of general data flows between the computer applications and actors implementing the social responsibility standards and monitoring the effects. By following the steps outlined in the process flow described below, an organization will embed standards and norms in a manner that
i. will improve its performance ii. enable it to achieve performance objectives
iii. entitle the organization to apply for certification as judged against standards and normative requirements and,
iv. monitor ongoing continuous improvement measures.

Each of these functions is delivered, and mediated by computer software applications. The invention can also be configured as a module of enterprise resource planning (ERP) computer applications.

### BACKGROUND OF THE INVENTION

Recent research indicates that organizations that adopt what is commonly referred to as ‘corporate social responsibility’ (CSR) principles to guide their decision-making and organizational management arrangements perform better (i.e., achieve objectives such as increasing revenue, improving service delivery, customer satisfaction, encouraging innovation etc.) than organizations that do not adopt CSR principles and values.

Organizations that wish to obtain the benefits of adopting CSR principles and values have previously been impeded in doing so for a range of reasons including:
being uncertain as to which CSR related standards and norms to adopt
the absence of a straightforward method guiding how best to implement the adoption of those standards and norms
time and resource intensity of the adoption and implementation process
measurement of implementation effectiveness including benchmarking against other organization's practices and performance
high costs associated with engaging external consultants

Therefore, what is needed is an electronic, computer-based and delivered ‘solution’ that is designed to guide organizations to systemically improve their operational performance by embedding CSR standards and related decision-making and behaviours within an organization. This process of embedding CSR standards and norms in decision-making and behaviour involves combining an externally derived normative framework of CSR standards with a second internally oriented organizational performance improvement framework, motivated third, by psychological drivers, which inform the implementation and improvement process.

The normative standards which establish the behavioural foundation upon which organizational/operational objectives are consistent with the psychology of cognition, motivation and organisational behavior. These three dimensions of the invention are synthesized into an organizational process that enables organizations to implement, measure and benchmark their compliance with the normative standards which are also reflected in organizational performance improvement.

In sum, normative standards are used to inform the content of organizational processes that are adopted and used by the behaviour of human actors that work within the organizations. In this way, the external institutional environment is coordinated with the internal organizational environment through the adoption of behaviours by human actors thereby coherently integrating three different units of analysis: institutions, organizations and people.

Pre-Condition #1: Determination and Synthesis of Normative Standards The first pre-condition underlying the structure of the invention deals with the normative standards upon which the invention is based. There is a debate within the CSR literature arising from the lack of clarity as to what subject matter fields and disciplines (fields) constitute the CSR regulatory space. In addition, it is unclear what normative standards (rules) within those fields are to be used to regulate actor behaviour.

Accordingly, in order to set the foundation for a coherent regulatory system, an architecture of the normative standards embodying both the appropriate fields and rules underlying the invention must be set.

In order to determine what CSR related regulation, organizational activities and which actors fall within the fields of, it is necessary to identify and categorize different sources of rules and different types of rules. The invention solves for the uncertainty associated with those two issues by applying a taxonomy of field and rules types derived from and using international legal conventions (sources). The problem that the taxonomy solves is that it organizes different types of rules from a range of sources and then places fields and rules in a general hierarchy of importance. The basic hierarchy is ordered as follows. At the top sits international public hard law rules (including international law recognized as customary law). Next rest the international public soft law rules. These are followed by rules formulated by private bodies such as standards setting industry associations (also soft law and often embedded through contract). Finally, lowest in the hierarchy are rules derived from industry specific custom and usage—often found in industry codes and referred to as best practice norms.

The subject matter fields can also be arranged in a manner that conforms to a general ranking of importance or priority. The normative foundations of CSR subject matter has evolved and been clarified sufficiently in recent decades so that they can be identified as: governance, management, business practices (anti-corruption), ethical trade practices (procurement and marketing), social practices (human rights, labour and safety), sustainable environmental practices and stakeholder engagement. These subject matter fields can be ranked on the basis of international norms that identify these fields and have either codified or guide their normative relevance. For example, higher-ranking fields as identified in the United Nations (UN) Global Compact principles are: human rights & labour, environment and anti-corruption. Other subject matter fields are ordered according to soft law norms identified in other UN and Organization for Economic Cooperation & Development (OECD) Guidelines, such as governance and management practices.

Pre-Condition #2: Configuring Organizational Performance Objectives A second pre-condition underlying the structure of the invention is that the rules described above must be embedded within the managerial and operational processes of organizations in a systematic manner. Furthermore, these rules can be implemented in a manner that is directed towards achieving specific performance improvement objectives. That is to say, certain rules within particular fields of CSR regulation are intrinsically related to specific performance improvement objectives. If these rules and performance objectives are better aligned, the implementation of these rules can be used to improve the performance of governance, managerial and operational processes within an organization.

Key areas of organizational improvement that can be linked to the implementation of the rules include improving:
the vision, mission and direction of an organization
the coordination of actors and tasks within an organization
the motivation of key actors, particularly management staff
the engagement of all actors, with particular emphasis on employees
processes and procedures that can contribute to reducing costs and increasing revenues
communication channels within the organization as well as with external stakeholders.

Where fields of CSR regulation and corresponding rules are implemented in a manner that is aligned with the performance improvement objectives described above, a combined outcome of improving performance and CSR compliance results.

Pre-Condition #3: Implementing the Psychology of Transformational Change The third pre-condition underlying structure of the invention is based on the psychology of cognition, motivation and organisations. This aspect of the invention links how people ‘think’ with how they ‘act’. In this regard, motivational psychology focuses on what causes people to act. Organisational psychology is about how groups work and the role of leadership.

People find deep thinking difficult. Studies show most people believe what they see and are told. Most are also deeply biased in their judgments. The invention is designed to work with people as they are, doing much of the difficult work of thinking through the issues, identifying and developing coherent norms, and providing a an implementation process in which all members of an organisation can participate. The implementation method is designed to avoid cognitive biases in groups by integrating processes by which errors are more likely to be discovered.

In addition, the implementation method is designed recognising that people have limited attention and benefit from clarity and simplicity in expression. Finally, the invention, using evidence from cognitive psychology, accentuates how people derive inspiration and motivation working with other people.

Individual motivation and its relationship to cooperation is an important aspect of the invention. Individuals within organizations must cooperate if the organisation wishes to achieve its objectives. Psychology indicates that people are motivated by a variety of things in addition to money. The most important motivators are: autonomy, mastery and recognition. The invention provides opportunities for individuals throughout organisations to exercise and demonstrate autonomy and mastery as well as opportunities for recognition or acknowledgement.

### SUMMARY OF THE INVENTION

The present invention provides an electronic communication system and network comprised of a computerized software application that performs a number of interactions with users of the application. In addition, the software application can communicate with other software applications hosted on the network as well as communicate with ERP systems to both extract and input relevant data.

The inventive concept resides in the fact that by using the computer application in conjunction with, and simultaneous to, the delivery and implementation of rules and processes any organization can:
i. calculate compliance measurement and benchmarking,
ii. calculate performance improvement measurement and
iii. enable continuous improvement measurement.
   These measures are calculated by the computer application and relayed back to the user in real time to indicate progress in the implementation process as well as in the post-implementation phase. A further inventive step is that the measurements mentioned above can be used to determine eligibility for certification and the degree of compliance with the rules.

### BRIEF DESCRIPTION OF THE DRAWINGS

In order that the invention may be more clearly understood, a preferred embodiment thereof will now be described in detail by way of example, with reference to the accompanying drawing, in which:

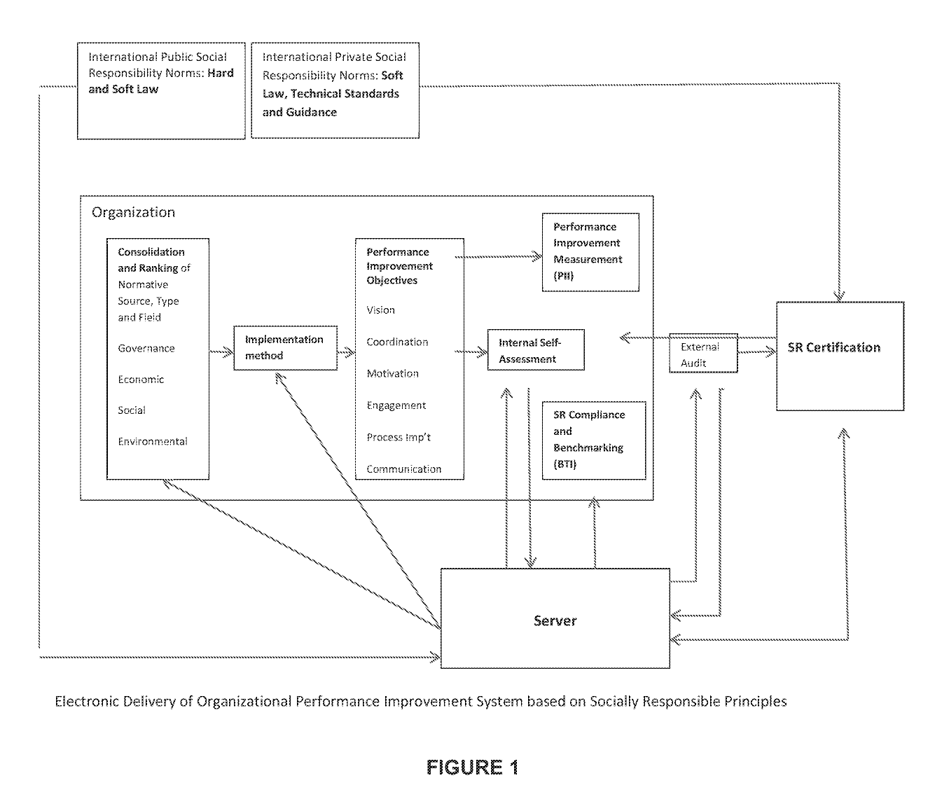

FIG. 1 is a flow chart illustrating the following components of the invention:
a rules and policies component
an organizational performance framework
an implementation method
compliance assessment
compliance benchmarking
performance improvement measurement
continuous improvement measurement
certification

### DESCRIPTION OF THE INVENTION

### The Rules Component

The first step in the process flow deals with setting the normative bases of the invention. This involves a user implementing the CSR modules of the invention, which have been previously ranked and consolidated to resolve the problem of what rules the user should implement. The rules are contained on the server and are distributed to users at an appropriate time in the implementation process as determined by the implementation method (below).

The rules are selected from a range of sources—all of which relate to some aspect of regulating CSR. The sources of rules are indicated in FIG. 1 in the box labelled “A”.

There are two broad sources of rules—those formulated by public international bodies such as the United Nations and those formulated by private international bodies. The source of the rules contributes to a determination of the legal status or types of the rules as being hard law or soft law. Hard law is binding in character, soft law, though voluntary, may become binding upon adoption as custom and usage or upon consent of application. Alternatively, soft law rules that are not adopted as binding may still be influential in setting a normative standard. Privately formulated rules are always soft law. They may take on the character of binding rules, as mentioned above, if their bindingness is consented to, usually by contract. Alternatively, private soft law norms can be adopted as binding according to the rules of custom, norm and best practice of a particular industry.

The sources and types of rules can be configured in a hierarchy of applicability according to the following order:
international public hard law (including treaty and recognized customary law)
international public soft law
private soft law adopted by consent
private soft law industry standards
industry best practice norms derived from custom and usage

In addition to the large number of international rule formulating bodies, there are a range of fields of rules that cover CSR related matters. There is no definition of what constitutes a CSR field. Nevertheless, through a process of surveying the subject matter of CSR-related rules, these rules can be grouped into nine general fields of CSR rule types including:
governance
business practices
procurement
marketing
human rights
labour
health & safety
environment & sustainability practices
stakeholder relations

The invention vets, ranks, consolidates the most relevant rules based on an evaluation using the hierarchical methodology described above. The rules are provided to the user by the software application at the point the user is required to implement those rules. The rules are provided to the user in the form of pre-prepared rule templates avoiding the need for users to draft documents that incorporate those rules.

### Performance Objective Framework

The performance objective framework is the second component of the system. It:
i. determines the sequence of the delivery of the rule-based charter, code, policy and procedure documents (described in the previous step)
ii. directs their delivery to achieve a particular performance objective via the most appropriate actors within an organization associated with and/or best able to achieve that objective in order to achieve a specific performance outcome—such as reducing costs and/or increasing revenue.

Organizations that have a clear vision and direction and have better coordinated information and task flows will function more effectively. Organizations that motivate and engage staff, employees and sub-contractors will function more effectively. Organizations that improve transactional and systemic tasks will improve process efficiencies. Finally, organizations that better harness and more systematically improve information flows with internal and external stakeholders will be more responsive, agile and innovative.

The invention organizes the rules, policies and procedures and aligns each field of rules and directs them towards achieving the performance improvement objectives of:
improving the broad vision and operational direction of the organization: this task is targeted to the very senior management of the organization (Board of Directors and Executive Officers) and is communicated by them to the staff, employees, sub-contractors and external stakeholders
improving the coordination of i. information ii. work units and iii. tasks within and between work units: is targeted in the first instance at a project manager/coordinator who engages in the process of identifying information, work units and actors that require better coordination
improving the motivation of employees by permitting autonomy, encouraging mastery and acknowledging their contribution to achieving the objectives of the performance improvement process: targeted at more senior levels of mana management
encouraging and improving engagement of operational staff and employees by allocating responsibility of implementing process improvement oriented rules and policies to those staff members
improve processes through employee led implementation of risk management and control systems
improve communication where all of the above functions, processes and tasks are linked through better communication channels both within an organization and with key actors external to the organization

### Implementation Methodology

The component of the invention described and labelled in FIG. 1 as “C” is the implementation method. The implementation method aligns the rules and performance improvement objectives by means of a sequential step/task/input process. The step/task/input requirements are provided to the user by the computer application.

Steps: The invention divides the implementation process is divided into seven (7) ‘Steps’. Each of the performance objectives is encapsulated in one or more of the seven steps. The computer software provides the user with the discrete steps in a sequence determined by the implementation method.

Tasks: The invention, through the implementation method, further divides each of the Steps into discrete Tasks, which the user is required to perform. The Tasks vary in number at each of the Steps. Each Task is directed towards some aspect of implementation that is described to the user within the content of each Task.

Inputs: After all of the Tasks for each Step are completed, the user is required to ‘Input’ data into the computer application. The ‘input’ data is entered through a computer interface. The input data is used by the computer application to provide assessments, benchmarking and performance improvement measurements and indications.

The computer application, through the provision of the implementation method to the user, also provides rule and process improvement implementation guidance supplied to the user in documentation and computer interfaces.

The rule template guidance relating to the implementation of policies and procedures follows a standard format, setting out:
Commitments: the organisation's commitments relating to each policy;
Objectives: the purpose and performance improvement objectives of each policy;
Scope/Responsibilities: the delegation of primary responsibility for relevant tasks to specific actors;
Approaches: the ways each performance improvement objective is to be achieved;
Additional implementation guidance: specific to each policy/procedure.

### Compliance Assessment and Benchmarking

The assessment and benchmarking module is a further module of the invention, which is labelled ‘D’ in FIG. 1. The assessment and benchmarking module receives the data ‘Inputs’ entered in a sequence determined by the implementation method (marked ‘C’ in FIG. 1).

The entry of the relevant data/inputs by the user is received by the computer application. The computer application uses the ‘input’ data to compute several measurements.

Organization Compliance Assessment: The input data the user is required to enter the input data which the computer application evaluates using the rule-based criteria and ranking as the measurement standard determined in the rule consolidation process (marked ‘A and B’ in FIG. 1). The calculation of the concordance between the extent of the implementation tasks completed and the requirements of all the rule standards determines the extent of organizational compliance with the rule standards. The concordance is provided to the user in the form of an assessment report that is generated by the software application.

Organization Benchmarking (Index): The organizational assessment report is then compared to the compliance performance of other organizations to the same set of rule standards. The computer application performs another set of calculations that enables the user to see how the user's organization compares in compliance terms with other organizations arranged by: i. industry ii. region, and iii. all organizations that are entering input data into the computer application.

The benchmarking calculation is done by the computer application by means of a weighted indexing evaluation and ranking.

### Performance Improvement Measurement

The assessment and benchmarking module is a further module of the invention, which is labelled ‘D’ in FIG. 1. The performance improvement module receives the data from the ‘Inputs’ entered in a sequence as determined by the implementation method (marked ‘C’ in FIG. 1). The date entry is received, processed and calculated by the computer application in order to provide the user with information relating to the progress of their implementation.

The data entered, processed and calculated by the computer application measures the degree to which the performance objectives—vision and direction, coordination, motivation, engagement, process improvement and communication—are being achieved in the course of the implementation. The degree of performance improvement is categorized by each of the objectives mentioned above and displayed to the user as a computer graphic and numerical measure. The higher the numerical measure calculated by the computer application indicates and corresponds to greater performance improvements for each of the categories measured.

### Continuous Improvement

The continuous improvement module is a further module of the invention, which is labelled ‘E’ in FIG. 1. The continuous improvement module receives data through the ‘Inputs’ entered by the user in a sequence determined by the implementation method (marked ‘C’ in FIG. 1). The data captured by the computer application measures and assesses the change in various factors such as changes in energy consumption, waste generation, water usage, complaints made, employee ideas or suggestions received, complaints or suggestions acted upon, disciplinary procedures activated (as measured by field) etc.

The data is entered, captured and processed by the computer application and provided to the appropriate user. The data is also cross-related to the rule/procedure compliance assessment as well as the performance improvement measurement. Changes in one of the measurement modules may impact and influence the measurement calculation by the computer application in relation to other modules.

### Certification

The final module embedded within the invention is the certification module, which is labelled ‘F’ in FIG. 1. The certification module draws data from several modules to calculate and assess whether an organization meets compliance thresholds and is eligible to be certified as compliant. The assessment and benchmarking module receives the data ‘Inputs’ entered in the sequence determined by the implementation method (marked ‘C’ in FIG. 1).

The data that is consolidated and calculated by the computer application is most closely linked to the compliance measurement module and the steps of the implementation method. To be eligible for certification, an organization must meet a minimum compliance threshold as calculated by the computer application. In addition, the organization must have completed all the implementation steps required by the implementation method. If both pre-conditions are met, an organization will be eligible to undertake an externally administered and conducted independent social audit for verification purposes.

In subsequent phases of the process where certification renewal occurs, the above requirements continue to apply with the added requirement of the organization meeting threshold continuous improvement requirements.

Finally, in addition to inputting data as required through the implementation process, the user will be required to upload specified documents as evidence of completion of the Step requirements. The computer application consolidates and stores all evidentiary documentation so that it is available for submission with the certification application.

The foregoing description, together with the accompanying figures, have set out details of the present invention, however, the disclosure is to be understood as illustrative of the preferred embodiments and changes may be made without departing from the scope of the invention, as set out hereafter in the claims.

1-7. (canceled)

8. A method of implementing social responsibility for an organization, comprising the steps of:
defining a plurality of fields of regulation each comprising a plurality of rules;
defining a plurality of performance improvement objectives;
defining a set of steps that will achieve one or more of the plurality of performance improvement objectives and comply with one or more of the plurality of rules;
selecting one or more fields from the plurality of fields of regulation;
selecting one or more rules from the plurality of rules within the one or more fields;
selecting one or more performance improvement objectives from the plurality of performance improvement objectives;
defining a subset of steps from the set of steps that will achieve the one or more performance improvement objectives while complying with the one or more rules;
providing a user with the subset of steps;
implementing the subset of steps to the operation of the organization to obtain data from the operation of the organization;
collecting the data upon completion of each of the subset of steps;
comparing the data against pre-determined standards of compliance with the one or more rules; and
providing the user with an assessment report of level of compliance with the one or more rules.

9. The method of claim 8, wherein the one or more fields are selected from a database comprising a plurality of fields of regulation collected from corporate social responsibility literature.

10. The method of claim 9, wherein the plurality of fields include governance, management, business practices, procurement, human rights, labour, health and safety, environment and sustainability practices, and stakeholder relations.

11. The method of claim 10, wherein plurality fields are organized into a hierarchy or importance.

12. The method of claim 11, wherein the one or more rules are selected from a database comprising a plurality of rules collected from international public hard law rules, international public soft law rules, rules formulated by private bodies, and rules derived from industry specific custom and usage.

13. The method of claim 12, wherein the plurality of rules are organized into a hierarchy of importance.

14. The method of claim 13, wherein each of the one or more steps is divided into a plurality of discrete tasks, which the user is required to perform.

15. The method of claim 8, further comprising the steps of:
comparing the assessment report with the level of compliance of one or more other organizations to the same one or more rules; and
providing the user with a benchmarking report comprising a ranking of organizations by their relative level of compliance with the one or more rules.

16. The method of claim 8, further comprising the steps of:
comparing the data against the one or more performance improvement objectives; and
providing the user with a performance assessment report of the degree to which the one or more performance improvement objectives are being achieved.

17. The method of claim 8, further comprising the steps of:
comparing the data received from the user upon completion of a first step of the subset of steps with the data received from the user upon completion of a second step of the subset of steps; and
providing the user with a report of the changes in the data between completion of the first step and the second step.

18. The method of claim 8, further comprising comparing the data against one or more certification requirements to determine eligibility for certification.
